(19) United States
(12) Patent Application Publication
(10) Pub. No.: US 2012/0018907 A1
(43) Pub. Date: Jan. 26, 2012

(54) Cooling Tower System With Chemical Feed Responsive to Actual Load

(76) Inventors: Stephen E. Dumler, Colleyville, TX (US); Blaine T.Y. Nagao, Keller, TX (US)

(21) Appl. No.: 13/215,950

(22) Filed: Aug. 23, 2011

Related U.S. Application Data
(63) Continuation-in-part of application No. 12/842,610, filed on Jul. 23, 2010.

(51) Int. Cl. B01F 3/04

(52) U.S. Cl. 261/26; 222/1; 222/52; 261/DIG. 11; 261/DIG. 46

(57) ABSTRACT

A system for controlling chemical feed to a cooling tower system may include a controller that may receive at least one input signal and send a control signal to a controllable feed apparatus to enable or disable the chemical feed to be delivered to the cooling tower system. The control signal may be sent in response to the at least one input signal. The system also may include a monitoring device to monitor consistency of the delivery of chemical feed to the cooling tower system. The monitoring device may send a monitor signal to the controller evaluating the consistency of the delivery of chemical feed to the cooling tower system.

### CROSS-REFERENCE TO RELATED APPLICATIONS

This application is a continuation-in-part of U.S. patent application Ser. No. 12/842,610, filed Jul. 23, 2010, and also claims priority under 35 U.S.C. §119, and the benefit of the filing date, of U.S. Provisional Application No. 61/228,150, filed Jul. 23, 2009, both applications which are incorporated by reference herein.

### FIELD OF THE INVENTION

The present disclosure relates generally to chemical feed systems, and more specifically, to chemical feed for a cooling tower system.

### BACKGROUND

Cooling tower systems may be used to remove heat, typically by circulating fluid, such as water, through one or more cooling towers. Cooling towers also may be used in conjunction with a heat exchanger that couples other fluids to the circulated water of the cooling tower, such as in an air conditioning cooling tower system or HVAC. Cooling tower systems may include a controlled source to supply new water (also known as make-up water) into the circulation system to replace water lost from the circulation process, such as through evaporation, removal of solids or other impurities through blow-down, bleed, or draw-off, and/or through drift, windage, spills and/or leaks. Cooling tower systems also may include apparatus to supply chemical(s) into the circulation system so as to provide a desirable level of stability to the circulating water, such as by reducing or inhibiting impurities or the negative effects of such impurities.

In the past, the supply (or “feed”) of chemical(s) into a cooling tower system has been controlled using various approaches. For example, a chemical pump may be electrically enabled to feed chemicals based on the amount of make-up water that a meter has determined was added. Meter use, however, may be costly, and meter failure may result in the chemical feed being improperly controlled. Further, the process may have a considerable deadband that may delay the addition or detection of make-up water and this also delays the chemical feed that only occurs after the detected makeup water volume exceeds a threshold. Feed and bleed systems also have been used to obtain a proper concentration of chemicals. These systems typically utilize sensors or probes to evaluate the conductivity of the circulating water, and as such, require the cost of the sensors as well as maintenance. There also may be a time lag before reaction resulting in improper chemical balance once make-up is performed. Moreover, undesirable chemical concentrations may expedite the wear on various system components, thereby decreasing operational efficiency and increasing both costs and maintenance.

### SUMMARY

Embodiments of the present disclosure may provide a system for controlling chemical feed to a cooling tower system comprising a controller that may receive at least one input signal and send a control signal to a controllable feed apparatus to enable, disable or otherwise adjust the chemical feed to be delivered to the cooling tower system. The control signal may be sent in response to the at least one input signal. The system also may include a monitoring device to monitor consistency of the delivery of chemical feed to the cooling tower system. One of the input signals may be a monitor signal sent from a monitoring device that monitors the consistency of the delivery of the chemical feed to the cooling tower system. Input signals may include the monitor signal as well as a LOAD signal. Input signals also may be the monitor signal as well as the LOAD signal and a CYCLES signal. The system also may comprise a chemical supply to deliver chemicals to the controllable feed apparatus, wherein the chemical supply may be coupled to the controllable feed apparatus through a supply line. The monitoring device may be removably associated with the system for controlling chemical feed. The monitoring device may be selected from the group comprising fluorometers, online analyzers, specific ion probes, online colormetric tests, electronic sensors, and chemical flow meters. The monitoring device may monitor the delivery of the chemical feed to give feedback to the LOAD signal.

Another embodiment of the present disclosure may provide a method of controlling chemical feed to a cooling tower system comprising monitoring output of chemical flow from a chemical delivery system, receiving at least one input signal wherein the input signal may include a monitor signal sent from a monitoring device, and sending a control signal to enable or disable chemical feed in response to the at least one input signal. Input signals may include a LOAD signal a CYCLES signal, and/or the monitor signal. Sending the control signal may comprise directing the controllable feed apparatus to deliver an amount of chemical feed proportional to a heat load imposed on a cooling tower system receiving the chemical feed. Sending the control signal also may comprise increasing the chemical feed to the cooling tower system in response to an increase in load on a cooling tower system. The control signal may be sent in real-time after a heat load has changed in a cooling tower system receiving the chemical feed.

Another embodiment of the present disclosure may provide a chemical delivery system comprising a chemical supply having a line coupled to an input of a controllable feed apparatus, the controllable feed apparatus operable to adjust chemical feed in response to a control signal sent from a controller, and a monitoring device to monitor consistency of delivery of the chemical feed by the controllable feed apparatus and deliver a monitor signal to the controller. The controller may send the control signal to the controllable feed apparatus in response to at least one input signal. Input signals may include a LOAD signal and/or the monitor signal. The monitoring device may be selected from the group comprising fluorometers, online analyzers, specific ion probes, online colormetric tests, electronic sensors, and chemical flow meters. The control signal may direct the controllable feed apparatus to deliver an amount of chemical feed proportional to a heat load imposed on a cooling system receiving the chemical feed.

### BRIEF DESCRIPTION OF THE DRAWINGS

FIG. 1 illustrates a functional block diagram of a cooling tower system according to embodiments of the present disclosure;

FIG. 2 illustrates a block diagram of a chemical delivery system according to an embodiment of the present disclosure; and

FIG. 3 illustrates a methodology and its results according to embodiments of the present disclosure.

### DETAILED DESCRIPTION

Embodiments of the present disclosure relate to a chemical feed system for a cooling tower system, where fluid (e.g., water) may be cooled through a cooling tower, then heated, such as through a heat exchanger, and then returned to a cooling tower for cooling in a somewhat circulating fashion. Embodiments of the present disclosure may be incorporated into an air conditioning system or HVAC, where cooled water from the cooling tower system passes to a chiller/heat exchanger (i.e., condenser) and removes heat from a separate chill side in the chiller/heat exchanger by transferring that heat to the water that is circulating to the cooling tower. However, embodiments of the chemical feed system may be incorporated into other systems without departing from the present disclosure.

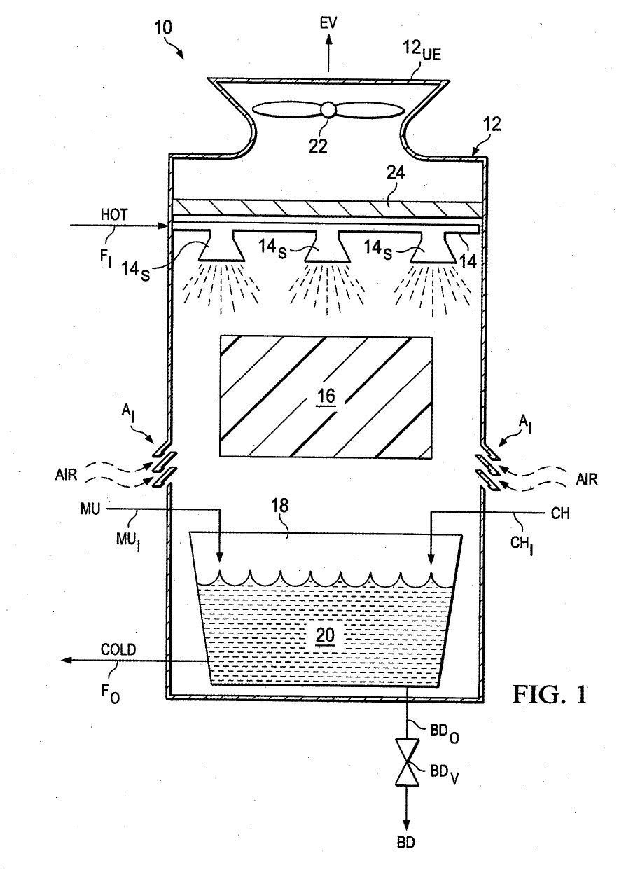

FIG. 1 depicts a functional block diagram of cooling tower system 10. System 10 may include cooling tower 12 wherein fluid (e.g., water) arrives at fluid input F_{I} at a higher temperature relative to when it exits at fluid output F_{O}. Input F_{I} may fluidly communicate with water distribution mechanism 14 that introduces the water toward the interior and near the top of tower 12 so that the fluid may flow downward. In certain applications, water distribution mechanism 14 may include spray nozzles 14_{S} so as to distribute the water in droplets of desired size and spray pattern to improve the heat transfer functionality of system 10.

Fill 16 (e.g., film or splash) may be located below water distribution mechanism 14. Fill 16 may be formed of various materials and shapes and provide surfaces over which the downward flowing water may travel to increase the surface area and time of contact between air and water so as to improve heat transfer from water to air.

Water basin 18 may be positioned below fill 16 to store water pool 20 that may capture water that flows past fill 16 and might not otherwise evaporate. Accordingly, tower 12 may receive relatively hot fluid at input F_{I}, and through an evaporative process, may cool the fluid for distribution via output F_{O}. More particularly, water and any chemicals or other matter therein may be distributed in a generally downward path from water distribution 14, through fill 16, and to water basin 18.

System 10 also may include accommodations for fluid loss and/or change of concentration of other materials circulating with fluid, such as due to evaporation or blow-down. As fluid loss occurs, the overall amount of circulating fluid may be reduced. To address this issue, in addition to receiving water from water distribution mechanism 14 (or elsewhere in the circulation path), water basin 18 may receive supply from two input sources MU_{I} and CH_{I}.

Input source MU_{I} may provide a make-up (MU) supply of water, and input source CH_{I} may provide a chemical (CH) feed of one or more chemicals to reduce or inhibit impurities and their effects on the system. Each input source (MU_{I} and CH_{I}) may add to the circulating water of system 10. While FIG. 1 may depict different entry points to water basin 18 for input sources MU_{I} and CH_{I}, they may enter the circulating path of the fluid at other points. It also should be appreciated that CH_{I} may be in the form of an eductor (or jet pump) and a valve may control the energy from the circulating fluid.

Circulating fluid also may be removed from water basin 18 (or elsewhere in the circulation path) via a blow-down (or bleed) output BD_{O}, which may cooperate with blow-down valve BDᵥ to provide blow-down (BD) waste and keep the amount of solids in the circulating fluid within an acceptable range. Tower 12 may include drift eliminator 24 so as to reduce water loss that otherwise could occur due to drift or windage.

Tower 12 also may include various attributes to facilitate the flow of air through it. In an embodiment of the present disclosure, tower 12 may include air inlets A_{I} to introduce ambient air into the interior of tower 12. Tower 12 also may include one or more of fan 22 corresponding to a tower cell to advance the air toward upper end 12_{UE} of tower 12. Fan 22 may be used in a mechanical draft tower system that may be further subdivided as an induced or forced system depending on the fan location. When water is introduced downward, air may enter tower 12 via inlets A_{I} and make contact with the downwardly traveling water, whether the air movement is forced via fan 22 or via the buoyancy of natural draft, such as through counterflow or crossflow. As a result, some of the downward traveling water may experience a phase change to vapor and may evaporate out of upper end 12_{UE} of tower 12.

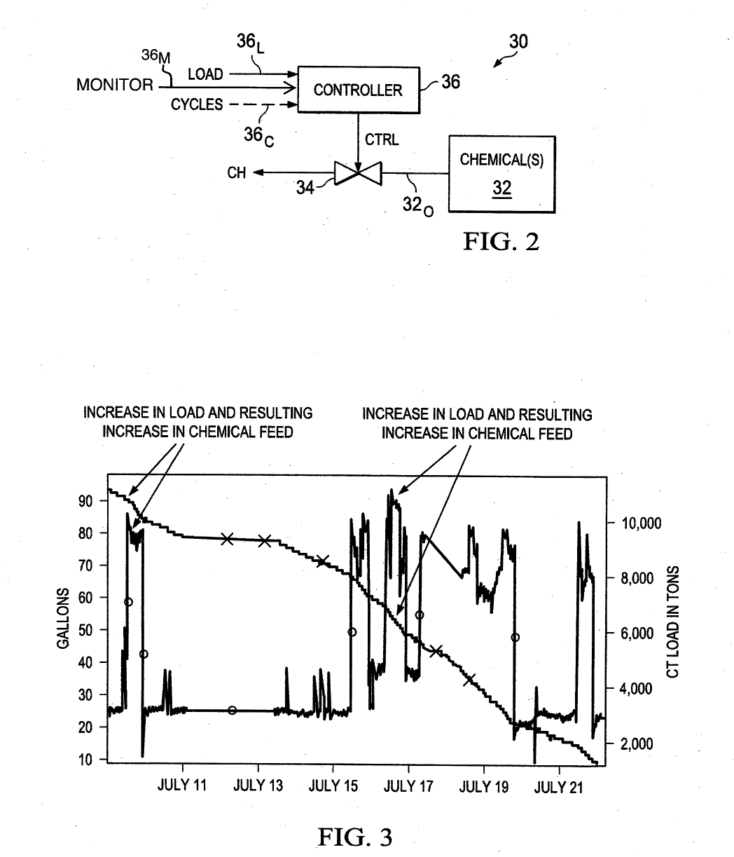

FIG. 2 depicts a block diagram of chemical delivery system 30, where system 30 may deliver chemicals (CH) to chemical input CH_{I} as depicted in FIG. 1. System 30 may include chemical supply 32, which may be any form of container or source to store chemicals desired for delivery to the circulating fluid of tower 10. Chemicals may be introduced to address or inhibit potential issues with respect to a water circulation system. Line or output 32_{O} of chemical supply 32 may be coupled to an input of controllable feed apparatus 34, where controllable feed apparatus 34 may be any apparatus that may enable, disable or otherwise adjust fluid flow, including but not necessarily limited to, a valve, pump, eductor, or the like.

Controllable feed apparatus 34 may be controlled by controller 36, which in an embodiment of the present disclosure may be a combination of electrical/electronic circuitry, including hardware and/or software, operable to receive at least one input signal and output a control signal. More specifically, controller 36 may operate to control controllable feed apparatus 34 and enable, disable or otherwise adjust fluid flow through it, by way of control signal CTRL in FIG. 2. Controllable feed apparatus 34 may be responsive to operate based on a control input. Controller 36 may receive a LOAD signal (or a multiplicand of LOAD) at input 36_{L}. Controller 36 also may receive a CYCLES signal at input 36_{C}. In response to at least one of these input signals, controller 36 may assert control signal CTRL to enable, disable or otherwise adjust the flow of chemicals from supply 32 to inlet CH_{I} through controllable feed apparatus 34. According to an embodiment of the present disclosure, the LOAD signal may be a separate signal from the CYCLES signal. However, in another embodiment of the present disclosure, an apparatus, such as circuitry or the like, may be used to combine or otherwise mix these signals.

The LOAD signal may be an electrical signal—analog or digital—representing a heat load imposed on tower 12. Load may be based on typical cooling tower design criteria. In an embodiment of the present disclosure, a system may provide a maximum amount of load, typically expressed in BTUs or tonnage (i.e., cooling tower tons), when operating at 100 percent. Various factors may affect load at a given time, such as thermostat setting(s) when the tower is in connection with an HVAC system, as well as ambient temperature, humidity, and/or pressure. Heat load is typically expressed as a product, which includes in its multiplicands the flow rate of water through tower 12 as well as the range, or the difference in water temperature between inlet F_{I} and outlet F_{O}. System 10 may be designed so that flow rate may be relatively constant and, therefore, range may vary, thereby changing the load on the system at different times. In an embodiment of the present disclosure, the LOAD signal may be directly or indirectly responsive to, or representative of, range and flow rate and may be obtained from various sources. For example, certain buildings include a Building Management System (BMS) that provides an electronic signal representative of load, where this signal may be used for tracking energy use and determining sufficiency and efficiency of existing cooling machinery. This information may be transmitted via wire or wirelessly. Further, the LOAD signal may be of various forms, including analog, fieldbus, or pulse proportional.

The CYCLES signal may be an electrical signal—analog or digital—that may be affected by the change in ratio of chemicals that has occurred between times that make-up water has been introduced into the circulating water. As make-up water is added along with, or followed by, the addition of chemicals, then water loss may occur (e.g., from evaporation, blow-down, or other loss), thereby changing the ratio of chemical concentration over time when water loss may have occurred. This ratio change may be referred to as CYCLES (or cycles of concentration), and may be mathematically represented according to the following Equation 1:

$$CYCLES = \frac{\begin{matrix}concentration of specific \\ chemical ( s ) in circulating water\end{matrix}}{\begin{matrix}concentration of specific chemcial ( s ) is \\ make \text{-} up water\end{matrix}} \qquad Equation 1$$

The Equation 1 determination of CYCLES may be provided by existing control systems or from within a control system as part of system 10. The calculation may be done in almost real-time; however, it may be calculated periodically and be manually added to the process calculation. One manner of evaluating CYCLES in accordance with Equation 1 may be using a sensor or the like that evaluates the concentration of at least one chemical in two different locations, where CYCLES is the ratio of the two concentrations. A cooling tower may be operated at a larger number of cycles within the range of operability but within limits to avoid fouling and the like, as a greater number of cycles may tend to reduce the amount of required blow-down, thereby reducing the amount of water loss and the amount of make-up (as well as chemicals associated with the make-up).

In an embodiment of the present disclosure, a monitoring device or mechanism may be employed with respect to chemical delivery system 30 to monitor levels of chemicals that may be fed into a cooling tower system from chemical delivery system 30. Such a monitoring device or mechanism may be a permanent component associated with chemical monitoring system 30 or it may be a removable component that may be utilized in conjunction with system at selected times to send MONITOR signal 36_{M} to controller 36. Such a monitoring device may identify issues that may arise related to the consistency of the output of chemical delivery system 30 that may feed into cooling tower system 10 (FIG. 1) and report them to controller 36. The monitoring device may send MONITOR signal 36_{M} to controller 36 within chemical delivery system 30, or an intermediate controller or computer system may communicate with a monitoring device to send MONITOR signal 36_{M} to controller 36 evaluating the consistency of the delivery of chemical feed to cooling tower system 10. Monitoring devices or mechanisms may include, but are not necessarily limited to, fluorometers, online analyzers, specific ion probes, online colormetric tests, electronic sensors, chemical flow meters, as well as other manually run laboratory methods using standard procedures known in the art.

FIG. 3 depicts an embodiment of the methodology and its results by plotting heat load relative to the right vertical axis (marked with o), and chemical consumption (marked with x) relative to the left vertical axis, both over time (depicted on the horizontal axis as a number of days including dates). In this embodiment of the present disclosure, controller 36 may issue control signal CTRL to controllable feed apparatus 34 to feed one or more chemicals proportional to the heat load represented by the LOAD signal imposed on cooling tower system 10. Controller 36 may issue this control signal in real-time or within a reasonably short lag in time (e.g., within one minute or even less than 10 seconds) after load changes so as to have a corresponding short window for controller 36 and controllable feed apparatus 34 to respond. The LOAD signal directing chemical feed may be transmitted to controller 36 via an intermediate controller or directly from a chiller load data source, for example. In response to the signal, a chemical feed volume may be produced that may be adjusted proportionally to the load, thereby providing chemicals into the circulating system commensurate with the then-existing heat load on the system.

The previously described operation may be appreciated by various embodiments depicted in FIG. 3. As a first example, prior to July 11, a transition occurs where load increases from a first period having level between 2,000 and 4,000 cooling tower tons to a second period having a level between 8,000 and 10,000 cooling tower tons. In response, controller 36 and controllable feed apparatus 34 may increase chemical coming from supply into the circulating fluid of tower 12 to feed during the second period a greater amount of chemical into the cooling tower system water as compared to that fed during the first period. This may be depicted in FIG. 3 by the greater downward slope corresponding to the second period, thereby indicating an increase of chemical consumption from supply 32 during the second period relative to the first period.

As a second example, from a third period spanning approximately July 11 to July 13, load remains relatively constant. In response, controller 36 and controllable feed apparatus 34 may reduce or even cease chemical provision from supply 32 into the circulating fluid of tower 12, particularly as compared to that fed during the second period, thereby providing only a very slight or no downward slope in chemical consumption during the third period.

There may be periods of larger heat load and a corresponding response of feeding a larger amount of chemical from supply 32 in response to those heat loads during those periods, with the sharper steepness of the downward slope illustrating the corresponding larger amount of chemical consumption from supply 32 during those periods. Conversely, the periods of lesser heat load and a corresponding response of feeding a lesser (or no) amount of chemical from supply 32 in response to those heat loads during those periods, with the lesser steepness of downward slope illustrating the corresponding lesser amount of chemical consumption from supply 32 during those periods.

Controller 36 may receive the CYCLES signal as an input representative of the then operating cycles of concentration of at least one chemical in the cooling tower circulating fluid. In this embodiment of the present disclosure, controller 36 may control controllable feed apparatus 34 not only in response to the LOAD signal, but also in response to the cycles of concentration as represented by the CYCLES signal and/or in response to the MONITOR signal sent to controller 36 from a monitoring device. More particularly, a larger number of cycles within the range of operability may reduce the amount of required blow-down, thereby reducing the amount of water loss and also reducing the amount of chemicals (and make-up). Thus, in this embodiment of the present disclosure, as the CYCLES signal may represent a relatively larger number of cycles, controller 36 may further cause controllable feed apparatus 34 to decrease the chemical feed from supply 32. Conversely as the CYCLES signal may represent a relatively lesser number of cycles, controller may further cause controllable feed apparatus 34 to increase the chemical feed from supply 32, both in combination with the additional indication of the LOAD signal and optionally the MONITOR signal.

According to an embodiment of the present disclosure, the following equations and accompanying discussion may depict how a chemical injection pump may be sized and how its feed rate in response to heat load may be calculated. First, the following Equations 2 through 6 are known to one skilled in the art:

evaporation gpm=χ ton load*design gpm per ton*design tower ΔT° F.*0.001*evaporation factor Equation 2

blowdown gpm=evaporation gpm/(cycles-1) Equation 3

make-up gpm=evaporation gpm+blowdown gpm Equation 4

Product volume per ton of load (lbs)=(make-up volume*target ppm)/120,000 Equation 5

Product volume per ton of load (gallons)=product volume per ton of load (lbs)/product lbs per gallon Equation 6

In an embodiment of the present disclosure, 120 ppm of product at a 1,000 ton load may operate at 4 cycles of concentration and a 10° F. Range (i.e., ΔT) with an evaporation factor of 1 and a design rate of 3 gpm per ton. Then, Equation 2 may be solved as shown in Equation 2.1:

evaporation gpm=30 gpm=1,000 ton load*3 gpm per ton*10*0.001*1 Equation 2.1

Equation 3 may be solved as shown in Equation 3.1:

blowdown gpm=10 gpm=30 gpm/(4-1) Equation 3.1

Equation 4 may be solved as shown in Equation 4.1:

make-up gpm=40 gpm=30 gpm+10 gpm Equation 4.1

The above calculations may be performed using apparatus and methodology known in the programmable apparatus art, such as through various combinations of hardware and software (including firmware).

Moreover, embodiments of the present disclosure may incorporate system-specific parameters into the determination of chemical feed, that is, given the indication of heat load, the resulting corresponding chemical feed may be responsive to both the heat load as well as to one or more parameters that may be specific to the particular implementation of the cooling tower system at issue (e.g., site-specific considerations). These parameters may include CYCLES and/or MONITOR signals. These system-specific parameters may be programmed into controller 36 and may be static or dynamic according to embodiments of the present disclosure. Thus, when the data generated above is combined with a chemical flow-metering device, controller 36 may determine parts per million (ppm) of product in the system. This determination may be used to adjust controllable feed apparatus 34 to allow a chemical output or flow to a target ppm from supply 32. An example of this calculation may be shown in Equation 7:

$$Product ppm = \frac{\begin{matrix}Chemical flow meter total in gallons * \\ product pound per gallon + 120 \text{,} 000\end{matrix}}{\begin{matrix}Calculated make \text{-} up * \\ actual ( or calculated ) cycles\end{matrix}} \qquad Equation 7$$

Cooling tower systems employing chemical delivery or feed systems according to embodiments of the present disclosure may reduce or eliminate metering inaccuracies or inconsistencies, as well as the costs and maintenance that accompany such aspects. More efficient/consistent delivery of chemical feed may improve the accuracy and use of chemicals in the feed, and therefore may provide more accurate chemical concentration within a cooling tower system. The real-time or very short time lag between load change (or cycle change) and the change in supply of chemical feed may provide a greater likelihood of a desirable concentration of chemicals in the cooling tower system.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for controlling chemical feed to a cooling tower system, said system comprising:
a controller that receives at least one input signal and sends a control signal to a controllable feed apparatus to adjust said chemical feed to be delivered to said cooling tower system, wherein said control signal is sent in response to said at least one input signal; and
wherein one of said at least one input signal is a monitor signal sent from a monitoring device that monitors consistency of said delivery of said chemical feed to said cooling tower system.

2. The system of claim 1, said system further comprising:
a chemical supply to deliver chemicals to said controllable feed apparatus, wherein said chemical supply is coupled to said controllable feed apparatus through a supply line.

3. The system of claim 1, wherein said monitoring device is selected from the group comprising:
fluorometers, online analyzers, specific ion probes, online colormetric tests, electronic sensors, and chemical flow meters.

4. The system of claim 1, wherein said at least one input signal is a LOAD signal and the monitor signal.

5. The system of claim 1, wherein said at least one input signal is a LOAD signal, a CYCLES signal, and the monitor signal.

6. The system of claim 4, wherein said monitoring device monitors said delivery of said chemical feed to give feedback to said LOAD signal.

7. The system of claim 1, wherein said monitoring device is removably associated with said system for controlling chemical feed.

8. A method of controlling chemical feed to a cooling tower system, said method comprising:
monitoring output of chemical flow from a chemical delivery system;
receiving at least one input signal, wherein said at least one input signal includes a monitor signal sent from a monitoring device; and
sending a control signal to enable or disable chemical feed in response to said at least one input signal.

9. The method of claim 8, wherein said at least one input signal includes a LOAD signal.

10. The method of claim 8, wherein said at least one input signal includes a CYCLES signal.

11. The method of claim 8, wherein sending said control signal comprises directing a controllable feed apparatus to deliver an amount of said chemical feed proportional to a heat load imposed on a cooling tower system receiving said chemical feed.

12. The method of claim 8, wherein sending said control signal comprises increasing said chemical feed to said cooling tower system in response to an increase in load on a cooling tower system.

13. The method of claim 8, wherein said control signal is sent in real-time after a heat load has changed in a cooling tower system receiving said chemical feed.

14. The method of claim 8, wherein said at least one input signal is received from an intermediate controller.

15. A chemical delivery system, said system comprising:
a chemical supply having a line coupled to an input of a controllable feed apparatus, said controllable feed apparatus operable to adjust chemical feed in response to a control signal sent from a controller; and
a monitoring device to monitor consistency of said delivery of said chemical feed by said controllable feed apparatus and to deliver a monitor signal to said controller.

16. The system of claim 15, wherein said controller sends said control signal to said controllable feed apparatus in response to at least one input signal.

17. The system of claim 16, wherein said at least one input signal includes said monitor signal.

18. The system of claim 17, wherein said at least one input signal includes a LOAD signal.

19. The system of claim 15, wherein said monitoring device is selected from the group comprising:
fluorometers, online analyzers, specific ion probes, online colormetric tests, electronic sensors, and chemical flow meters.

20. The system of claim 15, wherein said control signal directs said controllable feed apparatus to deliver an amount of said chemical feed proportional to a heat load imposed on a cooling system receiving said chemical feed.
